(19) United States
(12) Patent Application Publication
(10) Pub. No.: US 2011/0050153 A1
(43) Pub. Date: Mar. 3, 2011

(54) Control mechanism for accelerating magnetically suspended rotor

(76) Inventor: Randal David Stewman, St. George, UT (US)

(21) Appl. No.: 12/583,810

(22) Filed: Aug. 25, 2009

(51) Int. Cl. H02P 6/08; H02K 7/09

(52) U.S. Cl. 318/721; 310/90.5

(57) ABSTRACT

The present invention is a propulsion apparatus that is magnetically maintained and accelerated. The apparatus comprises a rotor rotating in a stator, the rotor magnetically maintained for rotation without friction by magnets situated in and on the rotor and stator. The rotor is rotated by pairs of magnets fixed to the rotor and stator. The first magnet of each magnet pair is fixed at a rotor placement point and the second magnet of each magnet pair is fixed on the stator at a fixed stator point. The second magnet of each magnet pair is an electromagnet that is activated by a control device. A vertical axis is defined such that the vertical axis passes through the center of rotation of the rotor. Each stator placement point is a point on a first line defined by kα, where α is a divisor of 360 degrees. Each rotor placement point is a point on a second line that is rotated β with respect to the first line. The control device selects m≧1 pairs of second magnets for activation to cause rotation of the rotor. If the first of the second magnet pair activated is on a line at γ with respect to the vertical axis, the second of the second magnet pair is on a line at −γ with respect to the vertical axis.

### RELATED APPLICATIONS

This application is related to and derives priority from US Provisional patent application entitled CONTROL MECHANISM FOR ACCELERATING MAGNETICALLY SUSPENDED ROTOR filed Aug. 25, 2008, which is incorporated herein by reference.

### FIELD

The present invention is a system and method for controlling the acceleration of a propulsion apparatus comprising a rotor magnetically sustained within a stator.

### BACKGROUND

A maglev, or magnetically levitating vehicle is a form of transportation that suspends, guides and propels vehicles (predominantly trains) using electromagnetic force. This method has the potential to be fast and quiet when compared to wheeled mass transit systems.

In electrodynamic suspension (EDS), both the rail and the vehicle exert a magnetic field, and the train is levitated by the repulsive force between these magnetic fields. The magnetic field in the vehicle is produced by either electromagnets or by an array of permanent magnets. The repulsive force in the rail is created by an induced magnetic field in wires or other conducting strips in the rail.

Propulsion coils on the rail are used to exert a force on the magnets in the vehicle and move the vehicle forward. The propulsion coils that exert a force on the vehicle are effectively a linear motor: An alternating current flowing through the coils generates a continuously varying magnetic field that moves forward along the rail. The frequency of the alternating current is synchronized to match the speed of the vehicle. The offset between the field exerted by magnets on the vehicle and the applied field create a force moving the vehicle forward.

Maglev concepts may have other applications, such as in magnetically suspended and propelled turbine devices, which will bring greater efficiency in reduction of friction and heat generation. However problems are encountered in the acceleration of magnetically suspended rotors due to unintended forces that disrupt equilibrium sustaining forces.

### OBJECTS

With respect to the need for efficient rotary mechanisms, it is therefore an object and advantage of the present invention to perfect an apparatus that may be magnetically sustained and driven.

A first benefit of the invention is a rotor that may be magnetically accelerated while maintaining friction-free rotation.

A second benefit of the present invention is an apparatus wherein the rotor may be accelerated by pre-selected and controlled magnetic forces.

Other benefits and advantages of the invention will appear from the disclosure to follow. In the disclosure reference is made to the accompanying drawing, which forms a part hereof and in which is shown by way of illustration a specific embodiment in which the invention may be practiced. This embodiment will be described in sufficient detail to enable those skilled in the art to practice the invention, and it is to be understood that other embodiments may be utilized and that structural changes may be made in details of the embodiments without departing from the scope of the invention.

### SUMMARY

The present invention is disclosed in an exemplary embodiment as a propulsion apparatus. The apparatus comprises the following components:
1. A rotor rotating in a stator, the rotor magnetically maintained for rotation without friction by magnets situated in and on the rotor and stator.
2. Pairs of magnets fixed to the rotor and stator. The first magnet of each magnet pair is fixed at a rotor placement point and the second magnet of each magnet pair is fixed on the stator at a fixed stator point. The second magnet of each magnet pair is an electromagnet that is activated by a control device.
3. A vertical axis is defined such that the vertical axis passes through the center of rotation of the rotor.
4. Each stator placement point is a point on a first line defined by kα, where α is a divisor of 360 degrees. Each rotor placement point is a point on a second line that is rotated β with respect to the first line.
5. The control device selects m≧1 pairs of second magnets for activation to cause rotation of the rotor.
6. If the first of the second magnet pair activated is on a line at γ with respect to the vertical axis, the second of the second magnet pair is on a line at −γ with respect to the vertical axis.

### BRIEF DESCRIPTION OF DRAWINGS

FIG. 1A illustrates the rotor that is magnetically sustained and moved within a stator.

FIG. 1B illustrates the rotor that is magnetically driven within the stator.

FIG. 1C shows a wheel attached to the rotor.

FIG. 1D shows a propeller attached to the rotor.

FIG. 1E illustrates the principles of contra-rotating propellers attached to the rotor.

FIG. 1F shows two contra-rotating propellers attached to the rotor.

FIG. 1G shows angular relationships of reference points used to place magnetic devices in the rotor and stator.

FIG. 1H also shows angular relationships of reference points used to place magnetic devices in the rotor and stator.

FIG. 2 depicts a computing environment for the control logic for selecting magnetic devices to rotate the rotor within the stator.

FIG. 3 illustrates the configuration of magnetic devices energized in relationship to points of reference on the rotor and stator.

FIG. 4 is a logic diagram of the method for magnetically controlling the rotor.

### DETAILED DESCRIPTION

### An Exemplary Embodiment

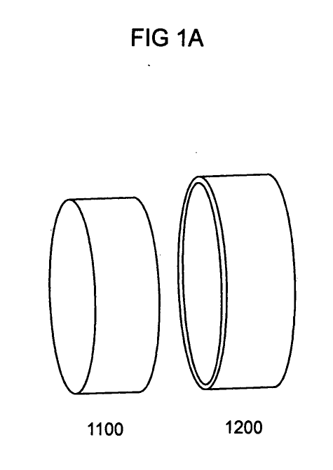

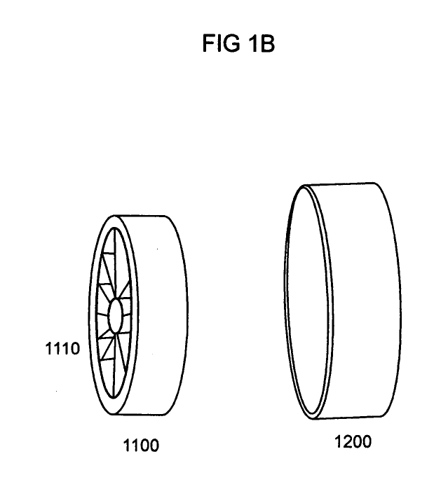

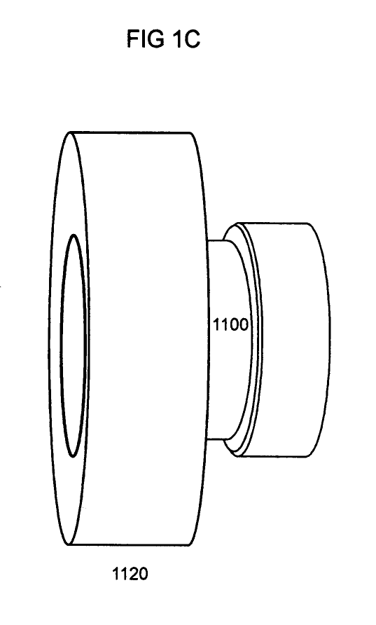

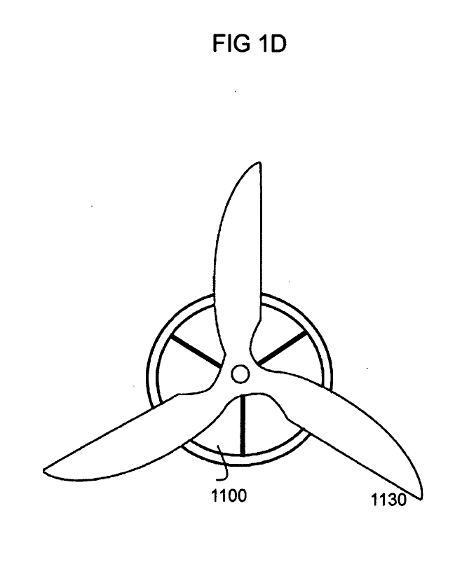

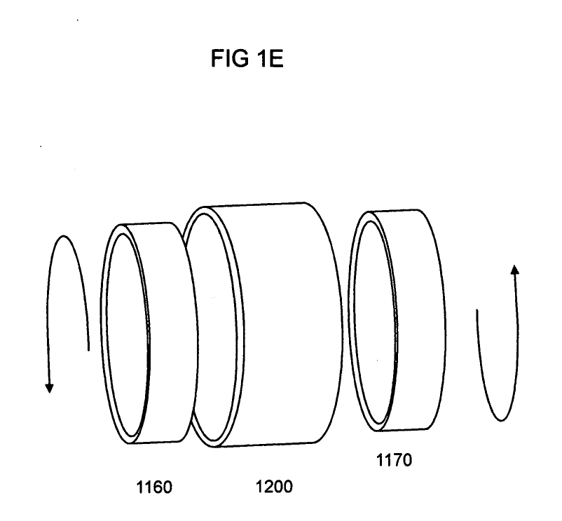

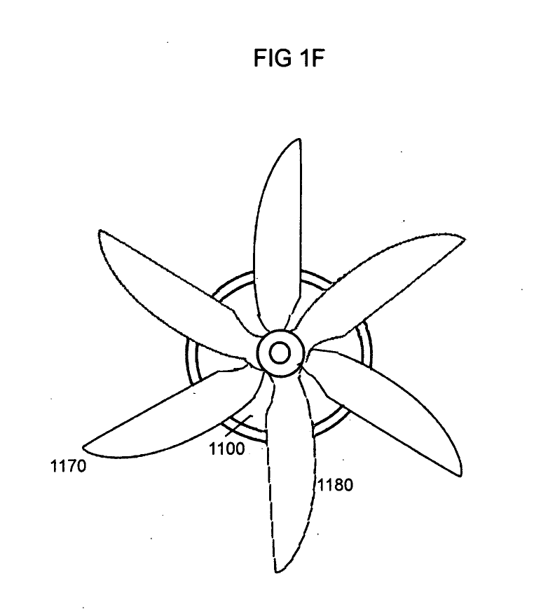

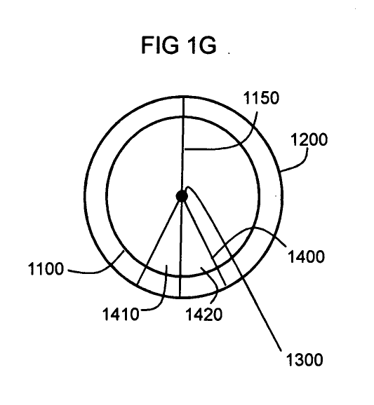

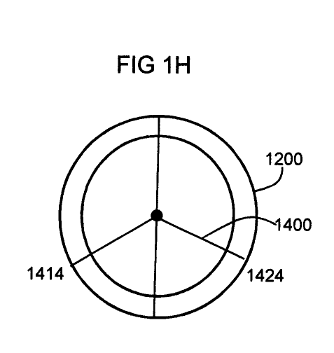

FIG. 1A shows an exemplary apparatus for practicing the invention, specifically a rotor 1100 magnetically sustained or suspended within a stator 1200. Magnetic devices for sustaining the stator 1100 are not shown but are disclosed and described in another patent application.

### Applications of the Invention

A traditional turbofan is a type of aircraft gas turbine engine that provides propulsion using a combination of a ducted fan and an jet exhaust nozzle. Part of the airstream from the ducted fan passes through the core, providing oxygen to burn fuel to create power. However, the rest of the air flow bypasses the engine core and mixes with the faster stream from the core. The rather slower bypass airflow produces thrust more efficiently than the high-speed air from the core, and this reduces the specific fuel consumption.

With reference to FIG. 1B, the invention may replace a traditional turbofan jet (or hot combustion gas) driven engine with the rotor 1100 and stator as described above that is driven and controlled utilizing the magnetic devices disclosed. In FIG. 1B, the rotor 1100 is configured with fan blades 1110 for engaging and propelling an airstream to produce thrust.

Now referring to FIG. 1C, the apparatus of the invention may be used to propel a vehicle by means of a drive (and support) wheel 1120 attached to the rotor 1100.

Further as shown in FIG. 1D, the rotor 1100 may be configured to receive a propeller 1130 to produce lift over a wing surface and to provide forward momentum to an aircraft.

Refer to FIG. 1E, wherein is shown a stator 1200 having two contra rotating rotors 1150 and 1160. The rotors 1150 and 1160 with the stator 1200 may be adapted or configured to receive and operate two propellers, which are made to contra rotate, with the blades adapted to produce thrust in the same direction. The two propellers 1160 and 1170 are shown with the front rotor 1150 shown in FIG. 1F.

### Operation of the Invention

With reference to FIG. 1G, the rotor 1100 is shown magnetically suspended in the stator 1200. The center of rotation 1300 is shown. A vertical axis 1150 is drawn through the center of rotation 1300. Also shown are radii 1400 drawn from the center of rotation 1300 to points on the stator 1200. The radii 1400 drawn as illustrated define an angle 1410 (hereafter called 6) and the negative of the same angle 1420 or −\acute{α}. The angle \acute{α} is chosen to be a divisor of 360 degrees.

In FIG. 1H, radii 1414 and 1416 define the angles k\acute{α} and −k\acute{α} made with respect to the vertical.

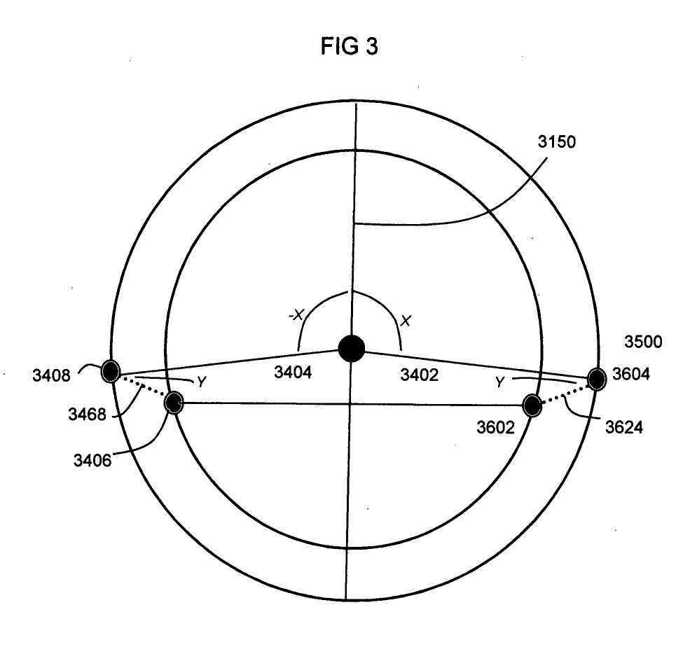

Now refer to FIG. 3. In FIG. 3 magnetic device pairs (3602, 3604) and (3406, 3408) are fixed on the apparatus. Magnetic devices 3602 and 3406 are permanent magnets and devices 3408 and 3604 are electrically activated and controlled by a control device associated with the apparatus. Devices 3408 and 3604 are fixed to the stator. Devices 3406 and 3602 are fixed to the rotor. Device 3604 is configured to be magnetically energized to be either opposite polarity to or the same polarity as device 3602 the radii 3402 and 3404. Device 3408 is configured to be magnetically energized to be either opposite polarity to or the same polarity as device 3406.

In FIG. 3, the radius 3402 makes an angle X with the vertical 3150. The radius 3404 makes the angle −X with respect to the vertical 3150.

In FIG. 3, if the magnetic devices 3602 and 3604 are energized, the line 3524 drawn between device 3602 and 3604 makes an angle Y with respect to the radius 3402.

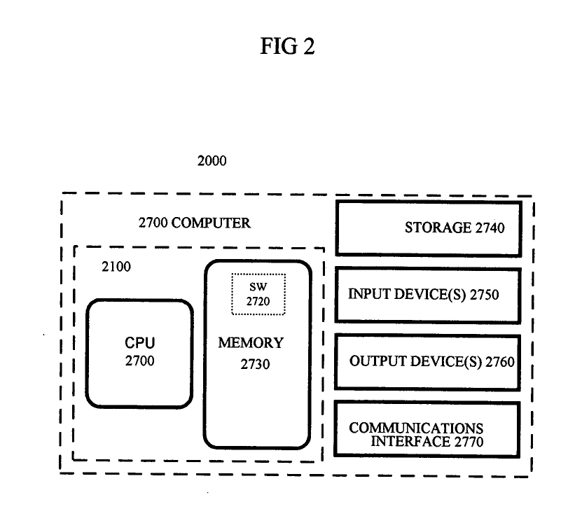

When devices 3602 and 3604 are selected, the control logic (illustrated in FIG. 2, with the description above) selects devices 3406 and 3608 for energizing. The devices 3406 and 3608 are selected according to the following criteria:
1. The device 3406 is selected such that the line drawn between 3602 and 3406 is perpendicular to the vertical 3150.
2. The device 3408 is selected so that if the radius drawn to 3604 is X, the radius drawn to 3408 is −X.
3. The polarity between 3604 and 3602 is minus the polarity between 3408 and 3406.

### Selection and Activation of Magnetic Devices on the Stator

Magnetic devices on the stator are selected and energized to rotate the rotor. The control mechanism is implemented within a computational framework shown in FIG. 2.

With reference to FIG. 2, the magnetic device selection, activation and control may be implemented (created, compiled, serialized, transmitted, deserialized, stored and executed); for example, within a computing environment 2000, which includes at least one processing unit 2700 and memory 2730. In FIG. 2, this most basic configuration 2000 is included within a dashed line. The processing unit 2700 executes computer-executable instructions and may be a real or a virtual processor. In a multi-processing system, multiple processing units execute computer-executable instructions to increase processing power. The memory 2730 may be volatile memory (e.g., registers, cache, RAM), non-volatile memory (e.g., ROM, EEPROM, flash memory, etc.), or some combination of the two. The memory 2730 stores executable software—instructions and data 2250—written and operative to execute and implement the software applications required for an environment supporting practice of the invention.

The computing environment may have additional features. For example, the computing environment 2000 includes storage 2740, one or more input devices 2750, one or more output devices 2760, and one or more communication connections or interfaces 2770. An interconnection mechanism (not shown) such as a bus, controller, or network interconnects the components of the computing environment to communications networks, where the apparatus may be controlled, updated or activated. Typically, operating system software (not shown) provides an operating environment for other software executing in the computing environment, and coordinates activities of the components of the computing environment.

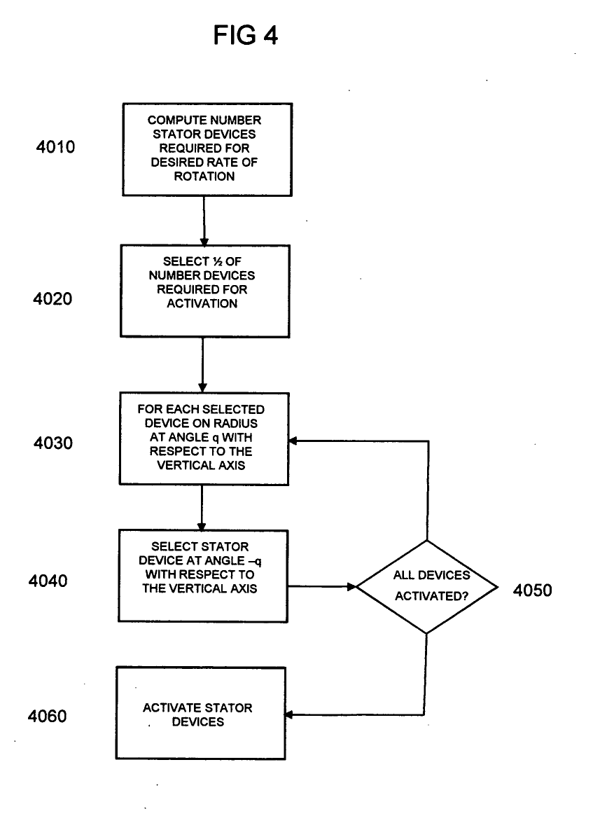

The storage 2740 may be removable or non-removable, and includes magnetic disks, CD-ROMs, DVDs, or any other medium which can be used to store information and which can be accessed within the computing environment. For example, the storage may store executable logic and data required to support the processes illustrated in FIG. 4. The storage 2740 also stores instructions for the software 2720, such as software for operating systems and web servers.

The input device(s) 2750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 2760 may be a display, printer, speaker, or another device that provides output from the computing environment.

The communication interface 2770 enable the operating system and software applications to exchange messages over a communication medium with sensor devices, and servo-mechanisms in various instantiations of the apparatus of the invention. The communication medium conveys information such as computer-executable instructions, software objects and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 2770 is used to communicate with other devices and computers. For example, the interface 2770 may be attached to a network, such as the Internet, whereby the computing environment 2000 interchanges command, control and feedback signals with other computers, devices, and machinery.

### DISCLOSURE SUMMARY

The present invention has been disclosed in an exemplary embodiment, which may be varied or altered according to specific requirements that are consistent with the inventive scope delineated by the claims that follow.

I claim:

1. In a propulsion apparatus comprising a rotor magnetically suspended in a stator, the rotor and stator having a center of rotation and a vertical axis passing through said center, a mechanism for accelerating said rotor, the mechanism comprising a plurality of magnetic pairs and a control device for selecting at least one magnet of said magnet pairs, wherein each magnet pair is situated on a first line extending from said center of rotation to a magnet attachment point on said stator, each said first line extending to the magnet attachment point defined by an integer multiple of a first constant angle with respect to said vertical axis, said first constant angle a divisor of 360 degrees, the second magnet of said magnet pair an electromagnet attached at said magnet attachment point, the first magnet of said magnet pair a permanent magnet attached to said rotor in closest proximity to said second magnet of the pair, said first magnet attached on second line rotated at a second constant angle with respect to said first line, wherein the control device selects at least two second magnets for magnetization.

2. The apparatus of claim 1, wherein said control device selects second magnets for magnetization according to the following scheme:
if first second magnet is on said line at angle alpha with respect to said vertical axis;
then second magnet selected is on line at angle alpha with respect said vertical axis.

3. The apparatus of claim 2, wherein said control device selects k second magnets, wherein k=2 n, with n>1.
